(19) United States
(12) Patent Application Publication
(10) Pub. No.: US 2003/0149635 A1
(43) Pub. Date: Aug. 7, 2003

(54) Process for customizing sweetener products and for ordering customized sweetener products through a communications network

(76) Inventors: Cindy A. Burklow, St. Louis, MO (US); Chifu Huang, St. Louis, MO (US)

Correspondence Address: Cindy Burklow, 169 Swigert Avenue, Lexington, KY, 40505, US

(21) Appl. No.: 10/067,073

(22) Filed: Feb. 4, 2002

(51) Int. Cl. G06F 17/60

(52) U.S. Cl. 705/26

(57) ABSTRACT

A process for making customized sweetener products available by a product supplier for online customizing sweetener products, online ordering the customized sweetener products, and online purchasing the customized sweetener products through a communications network made accessible to a customer.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

This invention relates to sweetener product customizing, ordering, and purchasing processes, and more specifically, to a process for making customized sweetener products available by the product supplier of the sweetener products for customizing, for ordering, and for purchasing of such customized sweetener products through the Internet or any communications network by a customer for customized sweetener products.

2. Description of Prior Art

In all industries, there have existed processes for customers to customize, order, and purchase such customized products from the product supplier. The simplest and earliest form of such processes for customers to customize, order, and purchase such customized products have basically included the following procedures or some variation thereof. The customer would visit the product supplier's facility and would request a product to be customized according to a certain specification thereafter the product supplier would acknowledge their ability as to whether they would be able to fulfill the customer's customization request. If the product supplier acknowledged that they could fulfill the customer's customization request thereafter the customer could, if the customer desired, place an order with the product supplier for the customized products, and purchase the customized products from the product supplier.

As time evolved and technology advanced, variations of the previously described process for customizing, ordering, and purchasing such customized products have been introduced or have just simply been put into practice. By way of example and not limitation, the following set of examples show variations to the previously described process where the customer chooses the most appropriate channels to communicate the customer's desire to customize, order, and purchase such customized products either by mail, phone, fax, email, or visit to the product supplier.

The first variation example is the customer visiting the facility of the product supplier for the purpose to view standardized products that can be customized by the customer selecting from a set of parameters (e.g. colors, size, extra special features) given by the product supplier to customize that particular standardized product thereafter if the customer desires can then place an order with the product supplier for the customized products and can purchase from the product supplier the customized products.

The second variation example is the product supplier sending sales representatives to the customer's facility to find out what specifications the customer has for products that the customer desires to customize or to show the customer some standardized products that can be customized according to a selection of parameters (e.g. color, size) offered by the product supplier. If the customer desires to customize products with the product supplier, then the customer can do so by either submitting specifications for customizing the product to the product supplier or by choosing from the selection of parameters offered by the product supplier to meet the customer's preferences thereafter if the customer desires can then order and purchase the customized products from the product supplier.

The third variation example is the product supplier providing the customer with a printed catalog of products that can be customized by the customer selecting from a set of parameters (e.g. color, size) offered by the product supplier and permitting the customer to request additional special features not included in the initial set of parameters offered by the product supplier to the customer thereafter if the customer desired could then customize the products, order the customized products, and purchase the customized products from the product supplier.

The fourth variation example is the customer attending a trade show to meet with the product supplier for the purpose of viewing the exhibited products that can be customized according to the customer's specifications by the product supplier thereafter the customer, if desired, could then customize the products with the product supplier, order the customized product from the product supplier, and purchase the customized products from the product supplier.

Another factor that creates more variations in the processes for customers to customize, order, and purchase such customized products is the type of customer seeking to customize, order, and purchase such customized products from the product supplier. Namely, whether the customer is a consumer customer (e.g. non-business customer) or a business/professional customer (e.g. retailer, manufacturer, distributor, supplier, wholesaler, restaurant, vendor, broker, trading company, doctor, consultant, researcher, any other type of business and service provider not aforementioned in this list). Depending on the particular industry, the processes for the consumer customer to customize, order, and purchase such customized products from the product supplier can differ from the processes for the business/professional customer to customize, order, and purchase such customized products from the product supplier. Specifically in the sweetener products industry, there is a noticeable difference between the processes for the consumer customer to customize sweetener products, order such customized sweetener products, and purchase such customized sweetener products from the product supplier versus the processes for the business/professional customer to customize sweetener products, order such customized sweetener products, and purchase such customized sweetener products from the product supplier.

By way of exemplification and not limitation, in the business/professional customer market, also known as business-to-business market, for sweetener products, the business/professional customer would order and purchase sweetener products through either a distributor, manufacturer, or wholesale vendor. If the business/professional customer chose to order and purchase sweetener products from any supplier other than the manufacturer or manufacturer distributor, through the channel of a trade show, a mail-order catalog, a phone ordering center, an Ecommerce website, then the sweetener products would already be formulated to meet specific sweetness levels and contain ingredients chosen by the manufacturer of the sweetener products. Hence under these circumstances, the business/professional customer is not able to customize the sweetener products, order such customized sweetener products, and purchase such customized sweetener products. However, if the business/professional customer chose to order and purchase sweetener products directly from the manufacturer or manufacturing distributor through the channel of a trade show, sales representative then the business/professional customer would be able to have the option to either order and purchase a pre-formulated sweetener product where the manufacturer designated the sweetness level and the ingredients or the business/professional customer could have the option to customize the sweetener products through a sales representative from the manufacturer or the manufacturer's distributor. However, none of the product suppliers including the manufacturer provides any processes for the business/professional customer to be able to online customize sweetener products, to online order such customized sweetener products, and to online purchase customized sweetener products through a communications network such as the Internet.

By way of exemplification and not limitation, in the consumer customer market, also known as business-to-consumer market, for sweetener products, the consumer customer would order and purchase sweetener products through an established vendor such as a grocery store, specialty store, department store, mail-order catalog, and online retailer's Ecommerce website. The one common factor for the consumer customers among all the aforementioned ways to order and purchase sweetener products is that the sweetener products are already pre-formulated to meet a certain sweetness level chosen by the product supplier of that specific sweetener product and the sweetener product already contains specific ingredients chosen by the product supplier. Hence, the consumer customer did not have a choice in the sweetness level of any of the sweetener products and the consumer customer did not have a choice in what ingredients were included in the sweetener products that they ordered and purchased from the product supplier. Namely, the product supplier did not provide a process for the consumer customer to customize, order, and purchase such customized sweetener products from the product supplier. There are no processes for the consumer customer to directly customize sweetener products, to directly order such customized sweetener products, and to directly purchase such customized sweetener products from the product supplier. Furthermore, the product supplier did not provide a process for the consumer customer to online customize sweetener products, to online order such customized sweetener products, and to online purchase such customized sweetener products from the product supplier through a communications network such as the Internet. Therefore, the product supplier does not provide an online process for both the business/professional customer and the consumer customer to online customize sweetener products, to online order such customized sweetener products, and to online purchase such customized sweetener products directly from the product supplier through a communications network such as the Internet.

Even though some product suppliers of sweetener products have Internet websites that promote their products and their services, all of these websites do not provide any online processes for customers, whether being consumer customer or business/professional customer, to online customize sweetener products, to online order such customized sweetener products, and to purchase such customized sweetener products through the Internet website and any communications network.

For this reason, the need of the customer to directly interact with the product supplier through a communication network created the need for this invention, namely, a process for the customer to online customize sweetener products, online order such customized sweetener products, and online purchase such customized sweetener products through a communications network such as the Internet, Intranet, or any other electronic communications network where the customer, including both the consumer customer and the business/professional customer, could customize sweetener products to their specification. Furthermore, since there is no process in existence for the consumer customer to directly customize sweetener products, to order such customized sweetener products, and to purchase such customized sweetener products from the product supplier, this need for a process for consumer customers has been evidenced in the prior art for such a customization process that our new and improved invention can fulfill.

It is also important to note that there are many disadvantages to the practices of the prior art for processes for customers to customize sweetener products, to order such customized sweetener products, and to purchase such customized sweetener products. These disadvantages in the practices of the prior art further created the need for a new and improved process for the customer to online customize sweetener products, to online order such customized sweetener products, and to online purchase such customized sweetener products from the product supplier. The first major disadvantage is cost. For the business-to-consumer market, one of the reasons why processes for the consumer customer to customize, order, and purchase such customized sweetener products were not offered to the consumer customer is in part due to the prohibitive cost factors, namely labor, inventory, labeling, and operational expenses. From a labor and operational viewpoint, there would be considerable costs for the product supplier to maintain a large staff of sales representatives to collect all the customization requests from consumer customers and to maintain a staff of skilled workers to produce all of the customized sweetener products. Furthermore, the practices of the prior art increased the product supplier's lead-time to produce the customized sweetener products. This increased lead-time means that in order for the product supplier to fulfill all of the consumer customer's customization requests in a timely fashion, it would be necessary for the product supplier to maintain a large inventory of various ingredients and numerous types of labels that would be needed to fulfill all the potential varieties of customizations that the consumer customer might request and this large inventory in addition to the printing of many labels would lead to greater expenses that the product supplier must cover in order to profitably benefit from offering such a customization process to the consumer customer. Therefore, under the practices of the prior art, the costs have out weighed the benefits for the product supplier to provide any processes for the consumer customers to customize sweetener products.

In order to be truly effective in both the consumer customer market and the business/professional customer market, a direct response channel would be needed, such as a customer service phone center where the customer could call in their customization requests, order such customized sweetener products, and purchase such customized sweetener products. This direct response approach must be able to accommodate the collecting and the processing of all the customization requests for the sweetener products, the orders for such customized sweetener products, and the purchase of such customized sweetener products in a fast, simple, and efficient manner. If the product supplier opted to use a direct response channel such as a phone center where the customers could call in their customization requests, then there would be a large labor expense to maintain a large enough staff of customers service operators to answer the phones and to collect customization requests from all the customers desiring to customize sweetener products, order such customized sweetener products, and purchase such customized sweetener products from the product supplier. In addition, there would be large asset costs to maintain the phone center facility itself (e.g. telephone lines, computers, building, insurance, office equipment). These cost factors alone would make the aforedescribed art prohibitive for the product supplier to offer such processes to the customer to customize sweetener products, to order such customized sweetener products, and purchase such customized sweetener products.

The second major disadvantage of the prior art is the time factor. The prior art had time constraints. For example and not limiting, the business/professional customer had to customize sweetener products, to order such customized sweetener products, and to purchase such customized sweetener products according to the product supplier's office hours, meaning that the customers did not have access to customize, to order, and to purchase such customized sweetener products 24-hours a day, 7-days week. Therefore, the customer had to customize the sweetener products, to order such customized sweetener products, and to purchase such customized sweetener products when it was convenient to the product supplier rather than when it was convenient to the customer. Furthermore, based on the practices of the prior art, the product supplier would have lost opportunities to procure international orders due to the conflict of time zones around the world. Another time constraint of the prior art is the amount of time it takes to process each individual customization request, each order of such customized sweetener products, and each purchase of such customized sweetener products. Under the practices of the prior art, it takes too long to efficiently process customization requests on the customer's demand and the lead-time from the receipt of the customer's customization request to the final fulfillment of that customization request takes too long for the product supplier, which further leads to accumulated labor and production costs for the product supplier.

The third major disadvantage of the prior art is the lack of sweetener product options for the customer of sweetener products. Since business/professional customers were the only customers offered the option to customize sweetener products, the consumer customer's options are more limited in comparison with the business/professional customer's options. Under all the previous practices of the prior art, the consumer customer only had the choice of ordering and purchasing sweetener products that the product supplier chose to supply to the customer. Therefore, the consumer customer did not have many choices of sweetener products to choose to order and to purchase. Besides, the product supplier would require the business/professional customer to agree to order and purchase a certain quantity of the customized sweetener products, usually a large volume, before the product supplier would even customize the sweetener products for the business/professional customer.

The fourth disadvantage of the prior art is that up to this time, there has not been an inexpensive and efficient mode for the product supplier to facilitate direct customization of sweetener products by the customer. Now with the advances in technology, the Internet and other communications networks provide the product supplier an effective, efficient, and cheaper channel to the previous art forms to provide a better mode to facilitate the process for the customer to customize sweetener products, to order such customized sweetener products, and to purchase such customized sweetener products directly from the product supplier.

Today's sophisticated customer, whether they be consumer or professional/business customers, are more apt to use, and often want to use, new technologies for direct communication with the product supplier. Today's communications networks provide the means to facilitate this new invention. The applicability of various technologies has helped to progress the need for new and improved processes to serve both the customer and the product supplier. Over the past several years, the Internet has provided the catalysis for the development of other patents. Namely, by way of exemplification and not limitation in this regard, reference is had herein, for instance, to U.S. Pat. No. 6,282,518, entitled “Process for Internet Ordering of Industrial Products”, which issued on Aug. 28, 2001. In accordance with the teachings of U.S. Pat. No. 6,282,518, there is provided a process for making industrial products, specifically AC drivers, available by the manufacturer of the industrial products for online ordering through a communications network. This aforementioned example shows the use of the Internet and other communications networks to facilitate a process to serve both the customer and the product supplier by providing a new and improved process for customers to order Industrial products directly from the manufacturer through the channel of the Internet. Another example, by way of exemplification and not limitation in this regard, reference is had herein, for instance, to U.S. Pat. No. 6,182,078, entitled “System for Delivering Professional Services over the Internet”, which issued on Jan. 30, 2001. In accordance with the teachings of U.S. Pat. No. 6,182,078, there is provided a system to deliver professional services to customers. This aforementioned example shows how the Internet can be used to facilitate the delivery of services to customers through the Internet and other communications networks. Another industry that has used the Internet and communications networks to facilitate a process to customize products is the personal computer industry. Another example, by way of exemplification and not limitation in this regard, reference is had herein, for instance, to U.S. Pat. No. 6,167,383, entitled “Method and Apparatus for Providing Customer Configured Machines at an Internet Site”, which issued on Dec. 26, 2000. In accordance with the teachings of U.S. Pat. No. 6,167,383, there is provided a method and apparatus for providing customer configured machines at an Internet site through providing a web-based online store includes a configurator, a cart, a checkout, and a database, further in which a user interface of the online store enables a custom configuration of a computer system according to an identification of a user belonging to a prescribed customer set. This aforementioned example shows how Dell Computer Corporation, uses their website to have their customers to configure (e.g. customize) computers and to order the computer that the customer has just configured (e.g. customized).

All three of the aforedescribed examples show how that the use of the Internet and communications network are used to provide a better mode of providing a cheaper and more efficient method to provide a service, facilitate a process, or produce a product. Likewise, a need has arisen in the prior art in the sweetener industry to also take advantage of the current technological advances namely the Internet and other communications networks to provide a new and improved process for customers to customize sweetener products, to order such customized sweetener products, and to purchase such customized sweetener products. Furthermore, a need has become self-evident in the practices of the prior art in the sweetener industry for a process to be provided by the product supplier for the consumer customer to customize sweetener products, to order such customized sweetener products, and purchase such customized sweetener products. Even more so, the practices of the prior art in the sweetener industry show a further need for a new and improved process for both the business/professional customer and the product supplier wherein the customer can online customize sweetener products, online order such customized sweetener products, and online purchase such customized sweetener products through a communications network made accessible to the customer, who want to customize sweetener products, order such customized sweetener products, and purchase such customized sweetener products. Therefore, all of these combined needs evidenced in the prior art for the sweetener industry call for a new and improved process for the product supplier to provide a process for the customer, including both consumer customer and business/professional customer, to online customize sweetener products, to online order such customized sweetener products, and to online purchase such customized sweetener products through a communications network made accessible to the customer.

This needed new and improved process, which has been evidenced in the prior art, has a number of characteristics. The first characteristic of such a new and improved process for customizing sweetener products, for ordering such customized sweetener products, and for purchasing such customized sweetener products is that this process makes available customized sweetener products by the product supplier thereof for online customizing sweetener products, for online ordering of such customized sweetener products, and for online purchasing of such customized sweetener products through a communications network made accessible to customers. The second characteristic of such a new and improved process is that this process permits any customer who has access to a communications network to be able to customize the sweetener products, to order such customized sweetener products, and to purchase such customized sweetener products any time of the day (24-hours a day), seven days a week, and from any location in the world that the customer chooses. The third characteristic of such a new and improved process is that this process enables the product supplier to query through a communications network to the customer as to whether the customer desires to customize sweetener products with the product supplier, to order from the product supplier for at least one of the customized sweetener products identified by the product supplier, and to purchase from the product supplier for at least one of the customized sweetener products identified by the product supplier. The fourth characteristic of such a new and improved process is that this process allows the product supplier to identify key parameters to offer to the customer whereby the customer can choose to customize the sweetener products to meet the customer's preferences and that this process also permits the product supplier to place these key parameters for customizing of the sweetener products supplied by the product supplier in a database and an electronic form for customizing of the sweetener products and to make this database and this electronic form accessible through a communications network to any customer for such customized sweetener products having access to the communications network. The fifth characteristic of such a new and improved process is that this process permits the customer for the sweetener products to connect through a communications network to the database and the electronic form containing the key parameters for customizing of the sweetener products supplied by the product supplier and this process further allows the customers having access to the communications network thereof to be able to customize sweetener products based upon the customer selecting from a plurality of key parameters (e.g. ingredients, sweetness levels, sizes, quantities) that are offered by the product supplier of the sweetener products whereby the customer can customize the sweetener products according to the customer's preferences. The sixth characteristic of such a new and improved process is that this process enables the product supplier to request through a communications network to the customer for the customer's choice of parameters from the plurality of key parameters for customizing the sweetener products supplied by the product supplier and to request through the communications network from the customer for additional specific information not listed in the plurality of key parameters for customizing the sweetener products supplied by the product supplier for subsequent assessment by the product supplier of such specific information. The seventh characteristic of such a new and improved process is that this process enables the product supplier to communicate through a communications network directly to the customer the identification of the customer's choice of parameters for customizing the sweetener products and any responses by the product supplier concerning any assessments on any additional specific information supplied by the customer to customize the sweetener products according to the customer's specifications. The eighth characteristic of such a new and improved process is that this process helps the product supplier to identify through a communications network to the customer the customer's choice of parameters from the plurality of key parameters for customizing of the sweetener products supplied by the product supplier and this process permits the product supplier to send acknowledgements through a communications network directly to the customer of the customer's desire to order and to purchase from the product supplier for at least one of the customized sweetener products identified by the product supplier. The ninth characteristic of such a new and improved process is that this process makes it possible for the customer of the sweetener products to communicate through a communications network to the product supplier the customer's choice of parameters from the plurality of key parameters for customizing the sweetener products supplied by the product supplier and to communicate any additional specific information that was requested by the product supplier for subsequent assessment by the product supplier of such specific information. The tenth characteristic of such a new and improved process is that this process permits the customer to communicate through a communications network to the product supplier for the sweetener products the customer's desire to customize with the product supplier for at least one sweetener product and the customer's desire to order and purchase from the product supplier for at least one of the customized sweetener products identified by the product supplier.

There are many benefits of such a new and improved process for the product supplier to provide a process for the customer to online customize sweetener products, to online order such customized sweetener products, and to online purchase such customized sweetener products through a communications network made accessible to the customer. One such benefit is that such a new and improved process provides a more convenient process for the customer to use and a more convenient process for the product supplier to implement. Another such benefit is that such a new and improved process can be made available to the customer 24-hours a day, seven days a week meaning that this process can open a window of more opportunities for the product supplier to procure more orders in addition to providing more time for the customer to customize sweetener products, to order and purchase such customized sweetener products rather than the limited hours of a work day or the constraints of the operational hours of trade shows and office hours of the product supplier. Yet another such benefit is that such a new and improved process has no geographic limits in that any customer from anywhere around the world can online customize sweetener products, online order such customized sweetener products, and online purchase such customized sweetener products. Another such benefit is that such a new and improved process is an optimization of all the prior art making it less expensive and more effective process to permit customers to online customize sweetener products, online order such customized sweetener products, and online purchase such customized sweetener products. Yet another such benefit is that such a new and improved process saves time for both the customer and the product supplier by allowing a quick, efficient, direct communication link between both parties. Another such benefit is that such a new and improved process is more cost-effective for the product supplier, because the product supplier can make exactly what the customer desires without having to make a large variety of sweetener products to try to meet all the various customer expectations. Yet another such benefit is that such a new and improved process provides the customer more options in sweetener products than what is now currently available in the sweetener market, specifically for customers that have special health concerns such as diabetes, allergies, or other special needs.

From the perspective of the product supplier, such a new and improved process is even more beneficial from both an operational and a marketing standpoint. From the operational standpoint, the product supplier receives the customization and the order directly from the customer in a more timely manner allowing the product supplier to have a shorter lead-time to produce the customized sweetener products, which means providing the customer faster service at a lower cost. In addition, such a new and improved process reduces the cost of preparing catalogs and any costs associated with distributing these catalogs to customers. From the marketing standpoint, the product supplier gains marketing research information on what type of sweetener products that the customer desires and the product supplier provides the customer exactly the type of sweetener products that the customer desires without guesswork from the product supplier, which means that this new and improved process saves money on having to maintain a large sales force that would be needed if using the practices of the prior art. Furthermore, all the information gained throughout the process, goes directly into a database quicker, which saves further on both time and the cost of re-entering ordering information. Finally, such a new and improved process allows the customer to directly interact with the product supplier in a non-pressuring environment.

The present invention provides a process that has all of the aforedescribed characteristics of such a new and improved process and the present invention provides all the benefits as aforedescribed for such a new and improved process.

### BRIEF SUMMARY OF THE INVENTION

It is an object of the present invention to provide a new and improved process for making available customized sweetener products by a product supplier thereof for online customizing sweetener products, online ordering customized sweetener products, and online purchasing customized sweetener products through a communications network made accessible to customers.

It is still another object of this present invention to provide a new and improved process that takes advantage of all current technological advances in electric/electronic communications including the Internet and all communications networks that is particularly well suited for the use in such a new and improved process.

It is another object of the present invention to provide a new and improved process that permits any customer who has access to a communications network to be able to customize the sweetener products, to order such customized sweetener products, and to purchase such customized sweetener products any time of the day (24-hours a day), any day of the week, and from any location in the world that the customer chooses.

It is still another object of the present invention to provide a new and improved process that enables the product supplier to query through a communications network to the customer as to whether the customer desires to customize sweetener products with the product supplier, to order from the product supplier for at least one of the customized sweetener products identified by the product supplier, and to purchase from the product supplier for at least one of the customized sweetener products identified by the product supplier.

It is still further another object of the present invention to provide a new and improved process that allows the product supplier to identify key parameters to offer to the customer whereby the customer can choose to customize the sweetener products to meet the customer's preferences and that this process also permits the product supplier to place these key parameters for customizing sweetener products in a database and an electronic form for customizing of the sweetener products and to make this database and this electronic form accessible through a communications network to any customer for such customized sweetener products having access to the communications network.

It is another object of the present invention to provide a new and improved process that permits the customers for the sweetener products to connect through a communications network to the database and the electronic form containing the key parameters for customizing of the sweetener products supplied by the product supplier and this process further allows the customer having access to the communications network thereof to be able to customize sweetener products based upon the customer selecting from the plurality of key parameters (e.g. ingredients, sweetness levels, sizes, quantities) that are offered by the product supplier of the sweetener products whereby the customer can customize the sweetener products according the customer's preferences.

It is still yet another object of the present invention to provide a new and improved process that enables the product supplier to request through a communications network to the customer for the customer's choice of parameters from the plurality of key parameters for customizing of the sweetener products supplied by the product supplier and to request through the communications from the customer for additional specific information not listed in the key parameters supplied by the product supplier for subsequent assessment by the product supplier of such specific information.

It is still another object of the present invention to provide a new and improved process that enables the product supplier to communicate through a communications network directly to the customer the identification of the customer's choice of parameters for customizing the sweetener products and any responses by the product supplier concerning any assessments on any specific information supplied by the customer to customize the sweetener products according to the customer's specifications.

It is still further another object of the present invention to provide a new and improved process that helps the product supplier to identify through a communications network to the customer the customer's choice of parameters from the plurality of key parameters for customizing of the sweetener products supplied by the product supplier and permits the product supplier to send acknowledgements through a communications network directly to the customer of the customer's desire to order and purchase from the product supplier for at least one of the customized sweetener products identified by the product supplier.

It is still yet another object of the present invention to provide a new and improved process that makes it possible for the customer of the sweetener products to communicate through a communications network to the product supplier the customer's choice of parameters from the plurality of key parameters for customizing the sweetener products supplied by the product supplier and to communicate any additional specific information that was requested by the product supplier for subsequent assessment by the product supplier of such specific information.

It is still yet further another object of the present invention to provide a new and improved process that permits the customer to communicate through a communications network to the product supplier for the sweetener products the customer's desire to customize with the product supplier for at least one sweetener product and the customer's desire to order and purchase from the product supplier for at least one of the customized sweetener products identified by the product supplier.

In accordance with the present invention there is provided a new and improved process for making available customized sweetener products by a product supplier thereof for online customizing sweetener products, online ordering the customized sweetener products, and online purchasing the customized sweetener products through a communications network made accessible to a customer therefor, the customized sweetener products being made available based upon a selection by the product supplier of such customized sweetener products of a plurality of key parameters for customizing the sweetener products therewith the customer selects parameters from such plurality of key parameters to customize the sweetener products provided by the product supplier whereby the customer customizes the sweetener products according to the customer's preferences thereby the product supplier produces the customized sweetener products according to the parameters selected by the customer from the plurality of the key parameters provided by the product supplier and for querying the customer as to the customer's desire to customize, to order, and to purchase for at least one of the selected customized sweetener products.

This new and improved process of the present invention comprises the following steps: of identifying by the product supplier the key parameters offered to the customer by the product supplier therewith the customer can choose from the plurality of key parameters to customize the sweetener products to meet the customer's desire; of placing the plurality of key parameters for customizing the sweetener products in a database and an electronic form of the sweetener products supplied by the product supplier that are available for customizing by the customer, ordering by the customer, and purchasing by the customer; of making the database and the electronic form of the plurality of key parameters for customizing sweetener products supplied by the product supplier that are available for customizing by the customer, ordering by the customer, and purchasing by the customer accessible through the communications network to any customer for such sweetener products having access to the communications network; of connecting by the customer for such sweetener products through the communications network to the database and the electronic form containing the key parameters for customizing sweetener products supplied by the product supplier; of querying by the product supplier through the communications network as to whether the customer for the sweetener products desired to customize with the product supplier for at least one sweetener product; of communicating by the customer through the communications network to the product supplier for the sweetener products the customer's desire to customize with the product supplier for at least one sweetener product; of requesting by the product supplier through the communications network to the customer for the customer's choice of parameters from the plurality of key parameters for customizing the sweetener products supplied by the product supplier; of communicating by the customer through the communications network to the product supplier the customer's choice of parameters from the plurality of key parameters for customizing of the sweetener products supplied by the product supplier; of requesting by the product supplier through the communications network to the customer for additional specific information not listed in the plurality of key parameters for customizing the sweetener products supplied by the product supplier for subsequent assessment by the product supplier of such specific information; of communicating by the customer through the communications network to the product supplier the customer's specific information that was requested by the product supplier; of communicating by the product supplier through the communications network to the customer the product supplier's response about the assessment on the specific information from the customer that was requested by the product supplier; of identifying by the product supplier of the customer's choice of parameters from the plurality of key parameters for customizing the sweetener products supplied by the product supplier; of communicating by the product supplier through the communications network to the customer the identification of the customer's choice of parameters for customizing the sweetener products and any specific information provided by the customer to customize the sweetener products; of querying by the product supplier through the communications network as to whether the customer for the customized sweetener products desired to order from the product supplier for at least one of the customized sweetener products identified by the product supplier; of communicating by the customer for the customized sweetener products through the communications network the customer's desire to order from the product supplier for at least one of the customized sweetener products identified by the product supplier; of querying by the product supplier through the communications network as to whether the customer for the customized sweetener products desired to purchase from the product supplier for at least one of the customized sweetener products identified by the product supplier; of communicating by the customer for the customized sweetener products through the communications network the customer's desire to purchase from the product supplier for at least one of the customized sweetener products identified by the product supplier; and of acknowledging by the product supplier through the communications network the customer's desire to order and to purchase from the product supplier for at least one of the customized sweetener products identified by the product supplier.

### BRIEF DESCRIPTION OF THE DRAWINGS

The foregoing and other teachings and advantages of the present invention will become more apparent upon a detailed description of the best mode for carrying out the invention as rendered below. In the description to follow, reference will be made to the accompanying drawings, in which:

FIG. 1 illustrates an overview block diagram of a process for making available customized sweetener products by the product supplier thereof for online customizing sweetener products, online ordering the customized sweetener products, and online purchasing the customized sweetener products through a communications network made accessible to customers;

FIG. 2 illustrates a flow chart diagram of the steps in the operation of the process for making available customized sweetener products by the product supplier thereof for online customizing sweetener products, online ordering the customized sweetener products, and online purchasing the customized sweetener products through a communications network made accessible to customers;

FIG. 3 illustrates a portion of an exemplary page of the product supplier showing the customer the steps to customize the sweetener products through a communications network and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers;

FIG. 4 illustrates a portion of an exemplary page of the product supplier requesting the customer to select a sweetness level to customize the sweetener products and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers;

FIG. 5 illustrates a portion of an exemplary page of the product supplier requesting the customer to select sweetening ingredients to customize the sweetener products and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers;

FIG. 6 illustrates a portion of an exemplary page of the product supplier requesting the customer to select base ingredients to customize the sweetener products and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers;

FIG. 7 illustrates a portion of an exemplary page of the product supplier requesting the customer to select a size to customize the sweetener products and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers;

FIG. 8 illustrates a portion of an exemplary page of the product supplier requesting the customer to submit any additional specific information such as special requests to customize the sweetener products and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers;

FIG. 9 illustrates a portion of an exemplary page of the product supplier requesting the customer to make a decision as to whether the customer desired to order and purchase the customized sweetener products and the exemplary page is generated in the course of utilizing the process, in accordance with the present invention, for making available customized sweetener products by the product supplier thereof for online customizing sweetener products, online ordering the customized sweetener products, and online purchasing the customized sweetener products through a communications network made accessible to customers.

### DESCRIPTION OF THE PREFERRED EMBODIMENT

A preferred embodiment of the present invention will be disclosed with reference to the attached drawings.

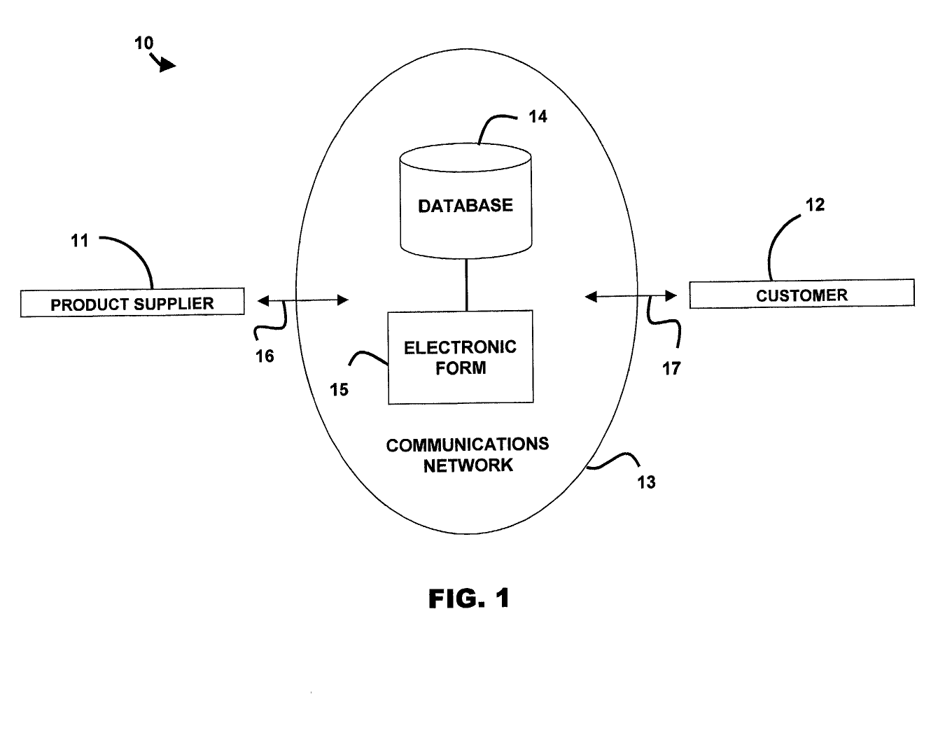

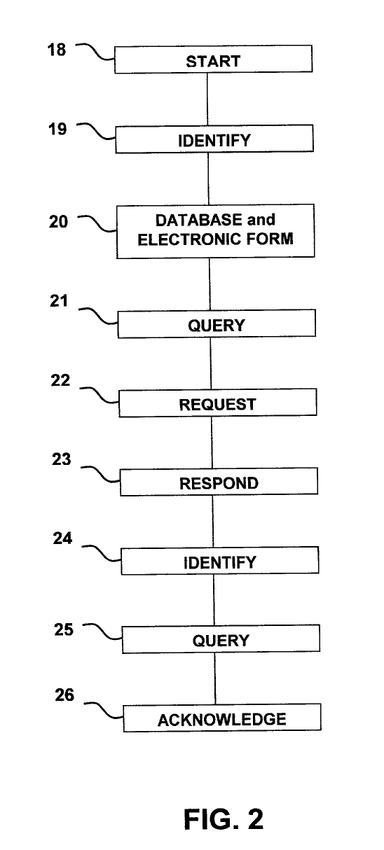

Now referring to FIG. 1 and FIG. 2 of the drawings, FIG. 1 and FIG. 2 illustrate the description of the process, designated by reference number 10 in FIG. 1, for making available customized sweetener products by a product supplier thereof for online customizing sweetener products, online ordering the customized sweetener products, and online purchasing the customized sweetener products through a communications network made accessible to a customer therefor, the customized sweetener products being made available based upon a selection by the product supplier of such customized sweetener products of a plurality of key parameters for customizing the sweetener products therewith the customer selects parameters from such plurality of key parameters to customize the sweetener products provided by the product supplier whereby the customer customizes the sweetener products according to the customer's preferences thereby the product supplier produces the customized sweetener products according to the parameters selected by the customer from the plurality of the key parameters provided by the product supplier and for querying the customer as to the customer's desire to customize, to order, and to purchase for at least one of the selected customized sweetener products

In further reference specifically to FIG. 1 of the drawings, FIG. 1 depicts a diagram of the process 10 for making available customized sweetener products by the product supplier thereof for online customizing the sweetener products, online ordering the customized sweetener products, and online purchasing the customized sweetener products through the communications network made accessible to customers. As illustrated in FIG. 1, the primary elements of the process 10 are the product supplier 11, the customer 12, a database 14, an electronic form 15, and the communications network 13. The product supplier's 11 interactions through the communications network 13 with the customer 12 are designated by reference number 16 and the customer's 12 interactions through the communications network 13 with the product supplier 11 are designated by reference number 17. It is best understood with reference to reference number 16 and reference number 17 of the FIG. 1, the product supplier 11 and the customer 12 are interacting and interconnecting with each other through the communications network 13. In accordance with the embodiment of the best mode of the present invention, the communications network 13 preferably comprises the Internet, but the communications network 13 could also comprise other forms of an electric/electronic communications network other than the Internet without departing from the essence of the present invention.

Now referring to FIG. 2 of the drawings, FIG. 2 illustrates the steps in the operation of the process 10 in accordance with the present invention. A description of these steps will now be had herein with reference in particular to FIG. 2 of the drawings. The first step in the operation of the process 10 begins with box labeled “START” 18 is the product supplier 11 starting the operation of the process 10. In accordance with the present invention, the next step in the process 10 thereafter is the second box labeled “IDENTIFY” 19 is the product supplier 11 identifying the key parameters to offer through the communications network 13 to the customer 12 by the product supplier 11 therewith the customer 12 can choose from the plurality of key parameters to customize the sweetener products to meet the customer's 12 desire.

The key parameters identified by the product supplier 11 are the key parameters in the selection of the plurality of key parameters offered by the product supplier 11 through the communications network 13 to the customer 12 therewith the customer 12 selects parameters from the plurality of key parameters to customize the sweetener products provided by the product supplier 11 whereby the customer 12 can customize the sweetener products according to the customer's 12 preferences thereby the product supplier 11 produces the sweetener products according to the parameters selected by the customer 12 from the plurality of the key parameters provided by the product supplier 11. Preferably, the key parameters comprise ingredients options, all sweetness levels options, sizes options, quantities ordered options, and any option factors that the product supplier 11 deems necessary to offer the customer 12 in order to assist the customer 12 to customize the sweetener products through the communications network 13, but the key parameters could also comprise other options provided by the product supplier 11 through the communications network 13 to the customer 12 for customizing the sweetener products without departing from the essence of the present invention.

In continued reference to FIG. 2, the next step in the process 10 thereafter is the third box labeled “DATABASE and ELECTRONIC FORM”, designated by reference number 20, is the product supplier 11 placing the plurality of key parameters for customizing the sweetener products in a database 14 and an electronic form 15 of the sweetener products supplied by the product supplier 11 that are available for customizing by the customer 12, ordering by the customer 12, and purchasing by the customer 12. The product supplier 11 makes the database 14 and the electronic form 15 of the plurality of key parameters for customizing sweetener products supplied by the product supplier 11 that are available for customizing by the customer 12, ordering by the customer 12, and purchasing by the customer 12 accessible through the communications network 13 to any customer 12 having access to the communications network 13. It is best understood that the customer 12 is connecting through the communications network 13 to the database 14 and the electronic form 15 containing the key parameters for customizing sweetener products supplied by the product supplier 11. Preferably, the electronic form 15 comprises a web page of website but the electronic form 15 could also comprise other forms of an electronic form other than the web page without departing from the essence of the present invention.

In reference still to FIG. 2, the next step in the process 10 is the box labeled “QUERY” 21 is the product supplier 11 querying through the communications network 13 to the customer 12 as to whether the customer 12 desired to customize with the product supplier 11 for at least one sweetener product. It is best understood with reference to reference number 21 of FIG. 2, the product supplier 11 queries through the communications network 13 to the customer 12 thereafter the customer 12 communicates through the communications network 13 to the product supplier 11 the customer's 12 desire to customize with the product supplier 11 for at least one of the sweetener products.

In further reference still to FIG. 2, the next step in the process 10 is the box labeled “REQUEST” 22 is the product supplier 11 requesting through the communications network 13 to the customer 12 for the customer's 12 choice of parameters from the plurality of key parameters for customizing the sweetener products supplied by the product supplier 11. Thereafter, the customer 12 communicates through the communications network 13 to the product supplier 11 the customer's 12 choice of parameters from the plurality of key parameters for customizing of the sweetener products supplied by the product supplier 11. Furthermore, the product supplier 11 is requesting through the communications network 13 to the customer 12 for additional specific information not listed in the plurality of key parameters for customizing the sweetener products supplied by the product supplier 11 for subsequent assessment by the product supplier 11 of such specific information. In return, the customer 12 is communicating through the communications network 13 to the product supplier 11 the customer's 12 specific information that was requested by the product supplier 11. Thereafter, the product supplier 11 communicates through the communications network 13 to the customer 12 the product supplier's 11 response about the assessment on the specific information from the customer 12 that was requested by the product supplier 11.

In further reference to FIG. 2, the next step in the process 10 is the box labeled “RESPOND” 23 is the product supplier 11 communicating through the communications network 13 to the customer 12 the product supplier's 11 response about the assessment on the specific information from the customer 12 that was requested by the product supplier 11.

In further reference still to FIG. 2, the next step in the process 10 is the box labeled “IDENTIFY” 24 is the product supplier 11 identifying the customer's 12 choice of parameters from the plurality of key parameters for customizing the sweetener products supplied by the product supplier 11. Moreover, the product supplier 11 is communicating through the communications network 13 to the customer 12 the identification of the customer's 12 choice of parameters for customizing the sweetener products and any additional specific information supplied by the customer 12 to customize the sweetener products.

In reference yet still to FIG. 2, the next step in the process 10 is the box labeled “QUERY” 21 is the product supplier 11 querying through the communications network 13 to the customer 12 as to whether the customer 12 desired to order from the product supplier 11 for at least one of the customized sweetener products identified by the product supplier 11. Thereafter, the customer 12 is communicating through the communications network 13 to the product supplier 11 the customer's 12 desire to order from the product supplier 11 for at least one of the customized sweetener products identified by the product supplier 11. Furthermore, the product supplier 11 is querying through the communications network 13 to the customer 12 as to whether the customer 12 desired to purchase from the product supplier 11 for at least one of the customized sweetener products identified by the product supplier 11. Thereafter, the customer 12 is communicating through the communications network 13 to the product supplier 11 the customer's 12 desire to purchase from the product supplier 11 for at least one of the customized sweetener products identified by the product supplier 11.

In further reference to FIG. 2, the next step in the process 10 is the box labeled “ACKNOWLEDGE” 26 is the product supplier 11 acknowledging through the communications network 13 to the customer 12 the customer's 12 desire to order and to purchase from the product supplier 11 for at least one of the customized sweetener products identified by the product supplier 11. After the product supplier 11 acknowledges through the communications network 13 to the customer 12 the customer's 12 desire to order and to purchase for at least one of the identified sweetener products from the product supplier 11 thereafter the product supplier can provide through the communications network 13 to the customer 12 the information that the customer needs in order for the customer 12 to pay for the identified customized sweetener products through the communications network 13 to the product supplier 11.

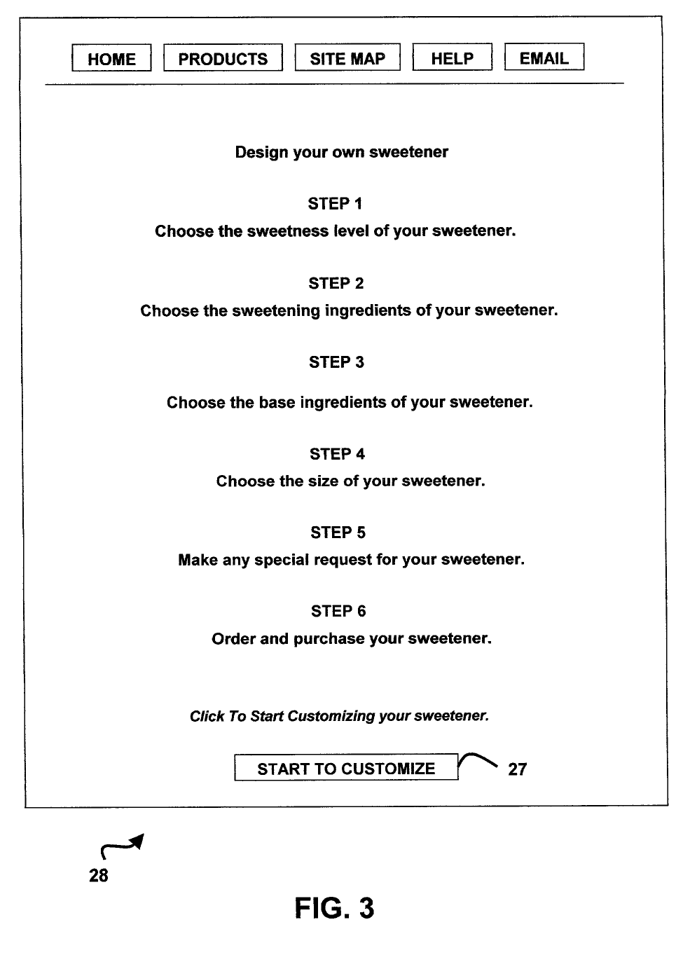

Reference will now be had to the remainder of the drawings, specifically FIG. 3 through FIG. 9. FIG. 3 through FIG. 9 are illustrations depicting exemplary pages that are generated for the customer 12 during the operation of the process 10 that the customer 12 would access through the communications network 13 for the purposes of utilizing the process 10. The exemplary pages illustrated in FIG. 3 through FIG. 9 are electronic forms. Preferably, the electronic form 15 comprises a web page of website but the electronic form 15 could also comprise other forms of an electronic form other than the web page without departing from the essence of the present invention. It is best understood with reference to FIG. 3 through FIG. 9 of the drawings, the customer 12 would access through the communications network 13 the electronic form 15. The following descriptions for reference drawings FIG. 3 to FIG. 9, will give a more detailed description of each exemplary page of the electronic form 15 that the customer 12 would utilize during the process 10. Furthermore, the product supplier 11 would provide such exemplary pages through the communications network 13 to the customer 11 for the added purpose to help the customer 11 customize the sweetener products. The specific exemplary pages depicted in FIG. 3 through FIG. 9 presented below is illustrative only and is not intended to limit the scope of the invention described herein.

In reference to FIG. 3 of the drawings, FIG. 3 illustrates an exemplary page, designated by reference number 28, that the customer 12 would access through the communications network 13 and this exemplary page 28 illustrates information provided by the product supplier 11 through the communications network 13 to the customer 12 on how to customize sweetener products through the communications network 13 with the product supplier 11. It is best understood with reference to reference number 28 of FIG. 3 of the drawings, the product supplier 11 queries through the communications network 13 to the customer 12 as to whether the customer 12 for the sweetener products desired to customize with the product supplier 11 for at least one sweetener product. Thereafter, if the customer 12 desires to customize sweetener products with the product supplier 11, the customer 12 can then communicate through the communications network 13 to the product supplier 11 the customer's 12 desire to customize the sweetener product with the product supplier 11. Preferably, the customer 12 communicates the desire to customize the sweetener products through the communication network 13 to the product supplier 12 by the customer 12 clicking on the button labeled “START TO CUSTOMIZE” 27.

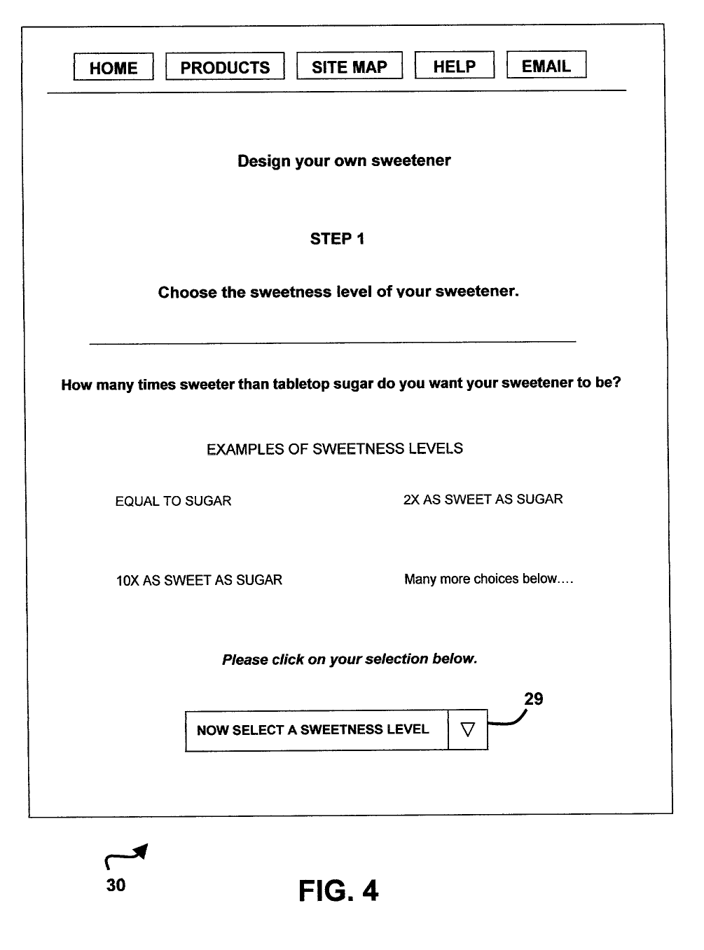

In reference to FIG. 4 of the drawings, FIG. 4 illustrates another exemplary page, designated by reference number 30, that the customer 12 accesses through the communications network 13 after the customer 11 has communicated through the communications network 13 to the product supplier 11 the customer's desire to customize the sweetener products with the product supplier 11. It is best understood with reference to reference number 30 of FIG. 4, the product supplier 11 requesting through the communications network 13 to the customer 12 for the customer's 12 choice of parameters from the plurality of key parameters for customizing the sweetener products supplied by the product supplier 11. The key parameters for exemplary page 30 are denoted by the selection box labeled “NOW SELECT A SWEETNESS LEVEL”, designated by reference number 29. All of key parameters are provided by the product supplier 11 through the communications network 13 to the customer 12 to help the customer 12 to customize the sweetener products by providing a plurality of key parameters 30 for the customer 12 to select 16 from thereby the customer 12 can customize the sweetener products to the customer's 12 preferences. In one embodiment, the key parameters offered by the product supplier 11 through the communications network 13 to the customer 12 in exemplary page 30 are the plurality of key parameters 29 of sweetness levels for customizing the sweetener products.

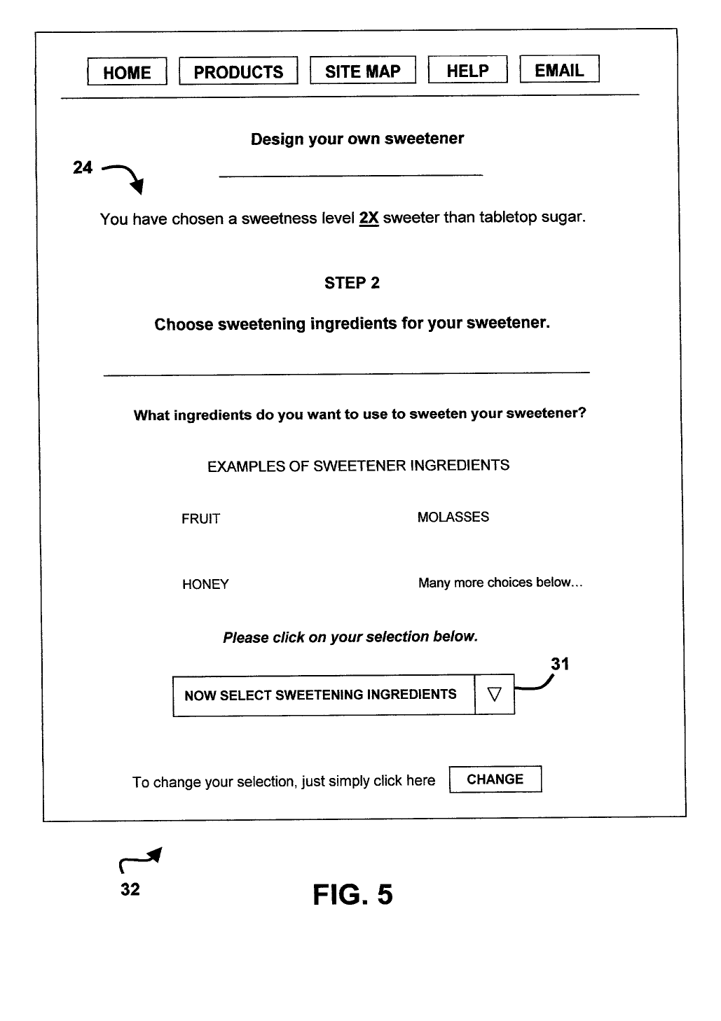

In reference to FIG. 5 of the drawings, FIG. 5 illustrates still another exemplary page, designated by reference number 32, that is offered by the product supplier 11 through the communications network 13 to the customer 12 to continue to help the customer 12 to customize the sweetener products. It is best understood with reference to reference number 32 of FIG. 5, the product supplier 11 identifies the key parameters that the customer 12 chose from the previous plurality of key parameters 29 provided by the product supplier 11 and in addition the product supplier 11 is providing even more plurality of key parameters 31 through the communications network 13 to the customer 12 to select from thereby to customize the sweetener products. The key parameters for exemplary page 32 are denoted by the selection box labeled “NOW SELECT SWEETENER INGREDIENTS”, designated by reference number 31. Furthermore, the product supplier 11 identifying the key parameters that customer 12 chose from the previous plurality of key parameters 29 provided by the product supplier 11 is denoted by a statement, designated by reference number 24, describing the customer's 12 choice of parameters. In another embodiment, the key parameters offered by the product supplier 11 through the communications network 13 to the customer 12 in exemplary page 32 are the plurality of key parameters 31 of sweetener ingredients for customizing the sweetener products.

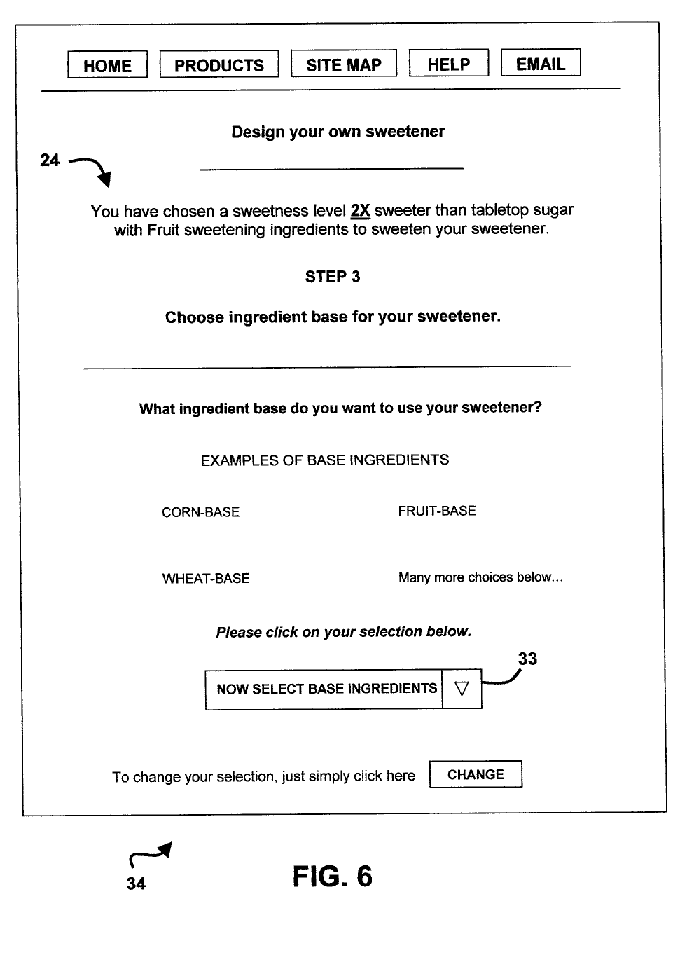

In reference to FIG. 6 of the drawings, FIG. 6 illustrates still yet another exemplary page, designated by reference number 34, that is offered by the product supplier 11 through the communications network 13 to the customer 12 to continue to help the customer 12 to customize the sweetener products. It is best understood with reference to reference number 34 of FIG. 6, the product supplier 11 identifies the key parameters that the customer 12 chose from the previous plurality of key parameters 31 provided by the product supplier 11 and in addition, the product supplier 11 is providing even more plurality of key parameters 33 through the communications network 13 to the customer 12 to select from thereby to customize the sweetener products. The key parameters for exemplary page 34 are denoted by the selection box labeled “NOW SELECT BASE INGREDIENTS”, designated by reference number 33. The product supplier 11 continues identifying the key parameters that the customer 12 chose from the previous plurality of key parameters 29, 31 provided by the product supplier is denoted by the statement 24 describing the customer's 12 choice of parameters. In another embodiment, key parameters offered by the product supplier 11 through the communications network 13 to the customer 12 in exemplary page 34 are the plurality of key parameters 33 of base ingredients for customizing the sweetener products.

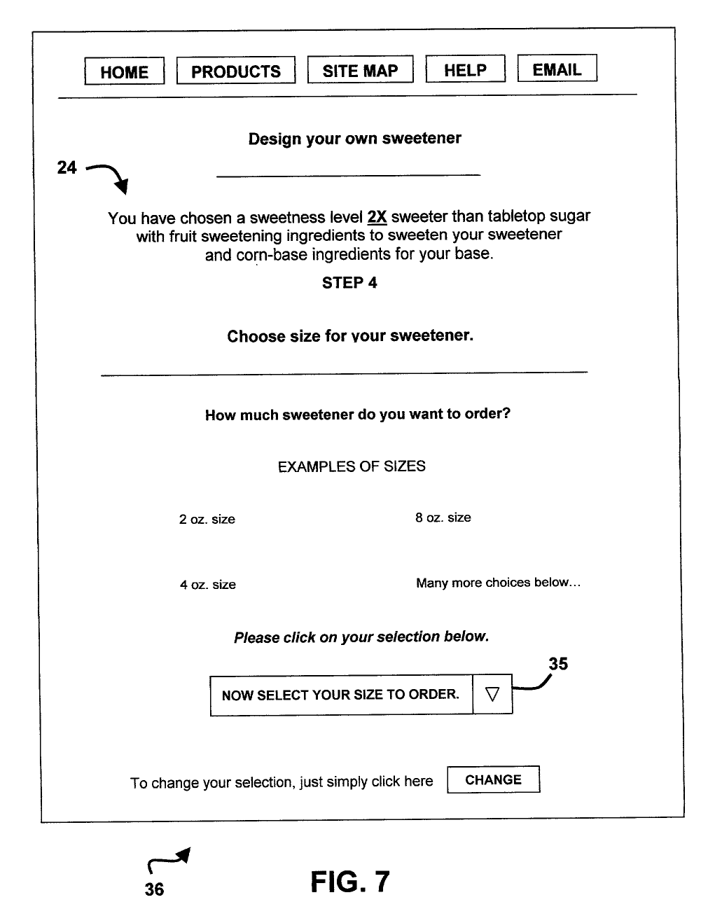

In reference to FIG. 7 of the drawings, FIG. 7 illustrates still even yet another exemplary page, designated by reference number 36, that is offered by the product supplier 11 through the communications network 13 to the customer 12 to continue to help the customer 12 to customize the sweetener products. It is best understood with reference to reference number 36 of FIG. 7, the product supplier 11 identifies the key parameters that the customer 12 chose from the previous plurality of key parameters 33 provided by the product supplier 11 and in addition, the product supplier 11 is providing even more plurality of key parameters 35 through the communications network 13 to the customer 12 to select from thereby to customize the sweetener products. The key parameters for exemplary page 36 are denoted by the selection box labeled “NOW SELECT YOUR ORDER SIZE”, designated by reference number 35. The product supplier 11 continues identifying the key parameters that customer 12 chose from the previous plurality of key parameters 29, 31, 33 provided by the product supplier 11 is denoted by the statement 24 describing the customer's 12 choice of parameters. In still another embodiment, key parameters offered by the product supplier 11 through the communications network 13 to the customer 12 in exemplary page 36 are the plurality of key parameters 35 of packaging sizes for customizing the sweetener products.

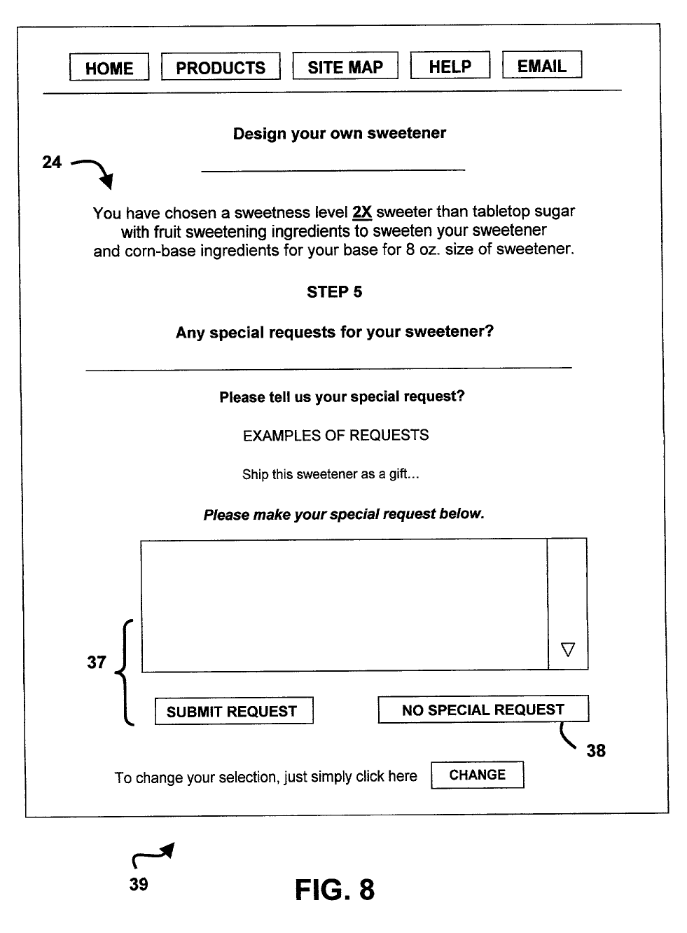

In reference to FIG. 8 of the drawings, FIG. 8 illustrates another exemplary page, designated by reference number 39, that is offered by the product supplier 11 through the communications network 13 to the customer 12. It is best understood with reference to reference number 39 of FIG. 8, the product supplier 11 is requesting through the communications network 13 to the customer 12 for the customer 12 to submit any additional specific information such as special requests for customizing the sweetener products thereafter if the customer 12 desires to submit any special request may then click on the button labeled “SUBMIT REQUEST” 37 and if the customer 12 desires not to submit any special request may then click on the button labeled “NO SPECIAL REQUEST” 38. The product supplier 11 continues identifying the key parameters that customer 12 chose from the previous plurality of key parameters 29, 31, 33, 35 provided by the product supplier 11 is denoted by the statement 24 describing the customer's 12 choice of parameters. In still another embodiment, the product supplier 11 requesting through the communications network 13 to the customer 12 for the customer 12 to submit any additional specific information such as special requests for customizing the sweetener products in exemplary page 39, but any specific information requested by the product supplier 11 through the communications network 13 to the customer 12 to customize the sweetener products could also comprise other special information requests by the product supplier 11 through the communications network 13 to the customer 12 other than the special requests by the customer for customizing the sweetener products without departing from the essence of the present invention

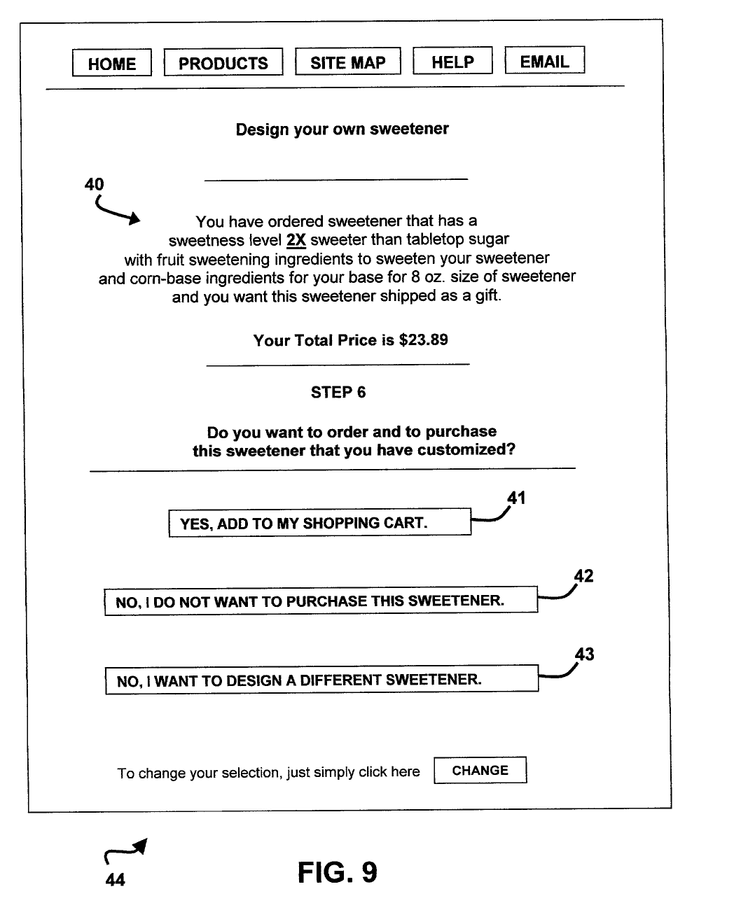

In reference to FIG. 9 of the drawings, FIG. 9 illustrates another exemplary page, designated by reference number 44, that is offered by the product supplier 11 through the communications network 13 to the customer 12. It is best understood with reference to reference number 44 of FIG. 9, the product supplier 11 identifies the final customized sweetener products that the customer 12 has customized through the communications network 13 and the product supplier 11 queries the customer 12 as to whether the customer 12 desires to purchase the identified customized sweetener products, designated by reference number 40. In reference still to reference number 44, if the customer 12 desires to purchase the identified customized sweetener products 40 from the product supplier 11, then the customer 12 can communicate through the communications network 13 to the product supplier 11 the customer's 12 desire to purchase the identified sweetener products 40 by the customer 12 clicking on the button labeled “YES, ADD TO MY SHOPPING CART” 41. In reference still to reference number 44, if the customer 12 does not desire to purchase the identified customized sweetener products 40 from the product supplier 11, then the customer 12 communicates through the communications network 13 to the product supplier 11 by the customer 12 clicking on the button that indicates the customer 12 declining to purchase denoted by the button labeled “NO, I DO NOT WANT TO PURCHASE THIS SWEETENER” 42 or the button labeled “NO, I WANT TO DESIGN A DIFFERENT SWEETENER” 43. After the customer 12 communicates through the communications network 13 to the product supplier 11 the customer's 12 desire to order and to purchase for at least one of the identified sweetener products 40 from the product supplier 11 thereafter the product supplier 11 acknowledging through the communications network 13 to the customer 12 the customer's 12 desire to order and to purchase from the product supplier 11 for at least one of the customized sweetener products identified by the product supplier 11. Thereafter, the product supplier 11 can accept payment through the communications network 13 from the customer 12 for the payment of the customized sweetener products.

Although the present invention has been described with reference to a particular arrangement of steps, features and the like, these are not intended to exhaust all possible arrangements, steps, features, and indeed many other modifications and variations will be ascertainable to those of skill in the art. Furthermore, while the embodiments have been particularly shown and described with reference to the various embodiments thereof, it will be understood by those skilled in the art that various changes in form and detail may be made therein without departing form the spirit and scope of the embodiments and the present inventions, as set forth in the claims of the present invention.

What is claimed is:

1. A process for making available customized sweetener products by a product supplier thereof for online customizing sweetener products, online ordering the customized sweetener products, and online purchasing the customized sweetener products through a communications network made accessible to a customer therefor, the customized sweetener products being made available based upon a selection by the product supplier of such customized sweetener products of a plurality of key parameters for customizing the sweetener products therewith the customer selects parameters from such plurality of key parameters to customize the sweetener products provided by the product supplier whereby the customer customizes the sweetener products according to the customer's preferences thereby the product supplier produces the customized sweetener products according to the parameters selected by the customer from the plurality of the key parameters provided by the product supplier and for querying the customer as to the customer's desire to customize, to order, and to purchase for at least one of the selected customized sweetener products comprising:
a. identifying by the product supplier the key parameters offered to the customer by the product supplier therewith the customer can choose from the plurality of key parameters to customize the sweetener products to meet the customer's desire;
b. placing the plurality of key parameters for customizing the sweetener products in a database and an electronic form of the sweetener products supplied by the product supplier that are available for customizing by the customer, ordering by the customer, and purchasing by the customer;
c. making the database and the electronic form of the plurality of key parameters for customizing sweetener products supplied by the product supplier that are available for customizing by the customer, ordering by the customer, and purchasing by the customer accessible through the communications network to any customer for such sweetener products having access to the communications network;
d. connecting by the customer for such sweetener products through the communications network to the database and the electronic form containing the key parameters for customizing sweetener products supplied by the product supplier;
e. querying by the product supplier through the communications network as to whether the customer for the sweetener products desired to customize with the product supplier for at least one sweetener product;
f. communicating by the customer through the communications network to the product supplier for the sweetener products the customer's desire to customize with the product supplier for at least one sweetener product;
g. requesting by the product supplier through the communications network to the customer for the customer's choice of parameters from the plurality of key parameters for customizing the sweetener products supplied by the product supplier;
h. communicating by the customer through the communications network to the product supplier the customer's choice of parameters from the plurality of key parameters for customizing of the sweetener products supplied by the product supplier;
i. requesting by the product supplier through the communications network to the customer for additional specific information not listed in the plurality of key parameters for customizing the sweetener products supplied by the product supplier for subsequent assessment by the product supplier of such specific information;
j. communicating by the customer through the communications network to the product supplier the customer's specific information that was requested by the product supplier;
k. communicating by the product supplier through the communications network to the customer the product supplier's response about the assessment on the specific information from the customer that was requested by the product supplier;
l. identifying by the product supplier of the customer's choice of parameters from the plurality of key parameters for customizing the sweetener products supplied by the product supplier;
m. communicating by the product supplier through the communications network to the customer the identification of the customer's choice of parameters for customizing the sweetener products and any specific information provided by the customer to customize the sweetener products;
n. querying by the product supplier through the communications network as to whether the customer for the customized sweetener products desired to order from the product supplier for at least one of the customized sweetener products identified by the product supplier;
o. communicating by the customer for the customized sweetener products through the communications network the customer's desire to order from the product supplier for at least one of the customized sweetener products identified by the product supplier;
p. querying by the product supplier through the communications network as to whether the customer for the customized sweetener products desired to purchase from the product supplier for at least one of the customized sweetener products identified by the product supplier;
q. communicating by the customer for the customized sweetener products through the communications network the customer's desire to purchase from the product supplier for at least one of the customized sweetener products identified by the product supplier;
r. acknowledging by the product supplier through the communications network the customer's desire to order and to purchase from the product supplier for at least one of the customized sweetener products identified by the product supplier.

2. The process of claim 1 wherein said sweetener products are all sweeteners, all natural sweeteners, all artificial sweeteners, all fruit sweeteners, all sweetening agents, all dietary ingredients that have sweetening attributes, all dietary supplements with sweetening attributes, all non-nutritive sweeteners, all nutritive sweeteners, all carbohydrate-based sweeteners, all combinations of natural sweeteners with artificial sweeteners, all combinations of natural sweeteners with natural sweeteners, all combinations of artificial sweeteners with artificial sweeteners, and all combinations of ingredients of sweeteners, bulking agents, fillers that produce a product that can be used as a sweetener and can be added to other products to sweeten.

3. The process of claim 1 wherein said sweetener products are all physical forms of sweetener products, all powder sweetener products, all liquid sweetener products, all granular sweetener products, all crystalline sweetener products, all gel sweetener products, all syrup sweetener products, and all solid forms of sweeteners products.

4. The process of claim 1 wherein said product supplier is manufacturer, wholesaler, vendor, distributor, retailer, consultant, all service professional in all industries, all business in all industries, and any business thereof not aforementioned in this list.

5. The process of claim 1 wherein said product supplier is the business that can provide customized sweetener products for the customer.

6. The process of claim 1 wherein said customer is all customer in all industries, all consumer customer, all business customer, all professional customer who desire to customize sweetener products, order such customized sweetener products, and purchase such customized sweetening products.

7. The process of claim 6 wherein said business customers are manufacturers, vendors, retailers, product suppliers, wholesalers, distributors, restaurants, bakeries, hotels, and any businesses thereof not aforementioned in this list in all industries.

8. The process of claim 6 wherein said professional customers are doctors, nurses, pharmacists, nutritionists, dietitians, consultants, chemists, scientists, researchers, chefs, food preparers, and any service providers thereof not aforementioned in this list in all industries.

9. The process of claim 1 wherein said key parameters are ingredients options, all sweetness levels options, sizes options, quantities ordered options, and any option factors that the product supplier deems necessary to offer the customer in order to assist the customer to customize the sweetener products.

10. The process of claim 1 wherein the product supplier queries through the communications network as to whether the customer desires to customize the sweetener products with the product supplier.

11. The process of claim 1 wherein the product supplier queries through the communications network as to whether the customer desires to place an order for the customized sweetener products with the product supplier.

12. The process of claim 1 wherein the product supplier queries through the communications network as to whether the customer desires to purchase the customized sweetener products from the product supplier.

13. The process of claim 1 wherein the customer communicates through the communications network to the product supplier the desire of the customer to customize the sweetener products with the product supplier.

14. The process of claim 1 wherein the customer communicates through the communications network to the product supplier the desire of the customer to place an order for the customized sweetener products with the product supplier.

15. The process of claim 1 wherein the customer communicates through the communications network to the product supplier the desire of the customer to purchase the customized sweetener products from the product supplier.

16. The process of claim 1 wherein said communications network is the Internet, electronic networks, inter-connected computer kiosks, intranets, intra-computer networks, local area networks (LANS), wide area networks (WANS), extranets, wireless communication networks, all electronic networks, electrical/electronic communications, and all communication networks.

17. The process of claim 1 wherein said electronic form is a web page, a website, an email, and all electronic form that can be transmitted through the communications network.

18. The process of claim 1 is for the whole process of customers customizing sweetener products through an electronic communications network, customers ordering customized sweetener products through the electronic communications network, and customers purchasing customized sweetener products through the electronic communications network.
